(19) United States
(12) Patent Application Publication
(10) Pub. No.: US 2011/0290405 A1
(43) Pub. Date: Dec. 1, 2011

(54) METHOD FOR THE PRODUCTION OF COMPOSITE HOLLOW ARTICLES

(76) Inventors: Martin Kaenzig, Wangenried (CH); Stefan Christ, Oensingen (CH); Rolf Singenberger, Echallens (CH)

(21) Appl. No.: 13/201,298

(22) PCT Filed: Feb. 13, 2009
(86) PCT No.: PCT/EP09/51710

§ 371 Date: Aug. 12, 2011

(51) Int. Cl. B32B 37/02; B32B 37/14; B32B 38/00; B32B 37/12

(52) U.S. Cl. 156/148; 156/184

(57) ABSTRACT

According to a method for the production of composite hollow articles, such as in particular tubular composite hollow articles, a braided fabric, a woven fabric or a laid fabric (5) is applied to an elongate supporting core (1) which consists essentially of an elastomer material or an at least partially plastic or flexible material. The braided fabric, woven fabric or laid fabric is then strengthened by means of a binder, whereupon the supporting core is removed once the binder has cured.

### RELATED APPLICATION

This application is a U.S. national stage application under 35 U.S.C. §371 of International Application No. PCT/EP2009/051710 filed Feb. 13, 2009.

### TECHNICAL FIELD

The present invention relates to a method for the production of tubular composite hollow articles.

### BACKGROUND AND SUMMARY

The production of tubular hollow articles from composite materials, such as so-called composite hollow articles, is known per se. Thus, for example, it is proposed to apply a stocking-like woven supporting fabric or laid fabric produced by means of so-called circular braiding machines to the outside of a tubular or cylindrical supporting body or to pull said woven supporting fabric or laid fabric over the latter.

A suitable binder, such as in particular a reaction resin, such as for example epoxy resin, polyester resin, polyurethane resin, etc., is then added to the laid fabric either by lamination or by means of injection molding, and the composite thus produced is cured by means of optional heat.

A disadvantage of this production method is that dimensional differences such as curvatures and differing diameters on the hollow article to be produced can generally scarcely be taken into consideration. Although it is possible during the production procedure, if appropriate, to locally widen the composite or composite tube produced, for example by means of pressure within the tubular or cylindrical supporting body, the applied laid fabric then generally has a reduced degree of strengthening at these points, since said laid fabric is likewise also widened.

It is therefore an object of the present invention to propose a method for the production of composite hollow articles, such as in particular tubular composite hollow articles, by means of which it is also possible to produce hollow articles which are at least slightly curved, have differing tube diameters or generally have differing dimensions.

According to the invention, the object set is achieved by means of a method of the invention wherein the method for the production of composite hollow articles, such as in particular tubular composite hollow articles, provides for a braided fabric or a laid fabric to be applied to an elongate supporting core which consists essentially of an elastomer material or a plastic material, and for said braided fabric or laid fabric to then be strengthened by means of a binder, whereupon the supporting core is removed once the binder has cured.

An alternative embodiment proposes applying the braided fabric or laid fabric to the supporting core by means of a so-called circular braiding machine, wherein, during the production of the laid fabric or braided fabric, the circular braiding machine is moved back and forth along the supporting body, for example locally, depending on the thickness of the laid fabric to be produced, wherein, in regions in which increased braided fabric or laid fabric density is to be achieved, the circular braiding machine is moved back and forth repeatedly or the local residence time in this region of the supporting core is increased.

The braided fabric is optimized in terms of loading depending on the tube shape and cross section. This is achieved by the number of filaments, the arrangement/orientation and by the braiding rate during insertion of the core.

By way of example, the elastomer material for the production of the supporting core may at least primarily be a silicone-like material. In this case, it is also possible to arrange one or more longitudinally running metal pins or metal wires within the elastomer material, such as for example the silicone-like material. It is important that the supporting body is dimensionally stable in spite of the fact that an elastic or plastic material is used.

For curing the binder, it can be advantageous, if appropriate, if the supporting core is heatable, which can be achieved for example by the arrangement of electrically conductive or thermally conductive fiber-, pin- or wire-like materials, heat being generated for example by applying an electrical current, in order to heat the supporting core. In turn, these may be metallic materials, such as for example copper wires, or else electrically conductive polymer materials, such as for example graphite, etc.

In order for it to be possible to remove the supporting core consisting, for example, of silicone from the interior of the hollow article once the composite hollow article has been produced, it can be advantageous to provide the elastomer core by means of a suitable release agent before the laid fabric or braided fabric is applied. Such release agents are extremely well-known per se, for example, from mold construction which makes use of epoxy resins, polyester resins or PU resins.

The application of the binder or the penetration of the woven fabric or laid fabric can be effected, for example, by means of lamination or else by means of injection molding, in that the supporting core with the woven fabric or laid fabric applied thereto is inserted into an appropriate injection mold.

Suitable binders are, in particular, reaction resins, such as for example epoxy resin, polyester resin, polyurethane resin, silicone resins, highly-crosslinking prepreg resins, etc. The selection of the resin depends on the ultimate demands made on the composite hollow articles to be produced, such as for example mechanical properties, resistance to chemicals, etc.

Depending on the demands made on the composite hollow articles, it can also be advantageous, if appropriate, to lay further fibers, yarns or filaments into the braided fabric or laid fabric, such as in particular filaments or yarns which run longitudinally along the supporting body and consist of glass fibers, graphite fibers, synthetic fibers such as polyamide fibers, flame-retardant fibers, metal fibers, etc.

According to a further alternative embodiment, in turn, it is possible, depending on the dimensional demands made on the composite hollow articles to be produced, to preform the elastomer supporting core before the woven fabric or laid fabric is applied. Bends, lesser or greater diameters, etc., in particular, can be produced in the elastomer supporting core, such as for example the silicone supporting core, before the braided fabric or laid fabric is applied. This is a substantial advantage compared to the presently known production techniques, where use is generally made of uniformly dimensioned supporting cores or cylinders and possible dimensional changes are produced by generating an excess pressure within the tubular supporting body, which can lead to the difficulties outlined in the introduction in relation to the composite hollow article ultimately produced.

### BRIEF DESCRIPTION OF DRAWINGS

The invention will now be briefly explained in more detail by way of example and with reference to the accompanying figures:

FIGS. 1a+1b schematically show the application of the braided fabric or laid fabric to the elastomer supporting body,

FIG. 2 schematically shows the elastomer supporting body with the braided fabric or laid fabric arranged thereon, and

FIG. 3 shows the ultimately produced composite hollow article, such as a tubular composite hollow article.

### DETAILED DESCRIPTION

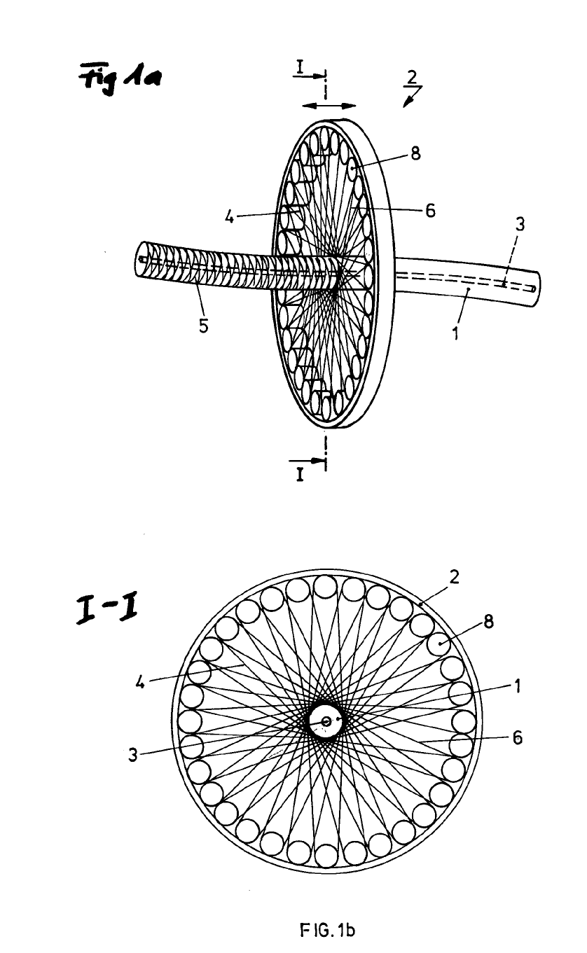

FIG. 1a shows schematically and in a longitudinal perspective how the braided fabric or laid fabric responsible for strengthening the composite hollow article is applied to an elastomer supporting core 1. Filaments 4 and 6, respectively, are braided onto the elastomer supporting body 1 by means of a circular braiding machine 2, which is represented schematically by reels 8. The procedure for applying the laid fabric or the braided fabric 5 is not dealt with in more detail at this point, since this procedure is extremely well-known from the prior art. It should merely be mentioned that by installing spacers or other suitable means, for example, it is possible to achieve a spacing between the braided fabric or the laid fabric and the elastomer body 1, so as to achieve the correct position of the laid fabric or woven fabric in the composite hollow article to be produced.

During application of the laid fabric onto the core, the circular braiding machine 2 is moved in the longitudinal direction along the elastomer core 1, the circular braiding machine, if appropriate, being moved to and fro at certain locations in order to locally produce a greater thickness of the braided fabric or laid fabric. This may be necessary particularly when there are bends in the supporting body, such that, for example given a uniform movement speed, the density would be lower at the surface of the outer, greater radius and the density would be increased in the region of the inner, smaller radius. This can be compensated for by moving the circular braiding machine to and fro.

FIG. 1b shows the system shown in FIG. 1a in section along the line I-I. Here, it can clearly be seen how the filaments 4 and 6 are braided onto the elastomer supporting body 1 in opposite directions from the reels 8.

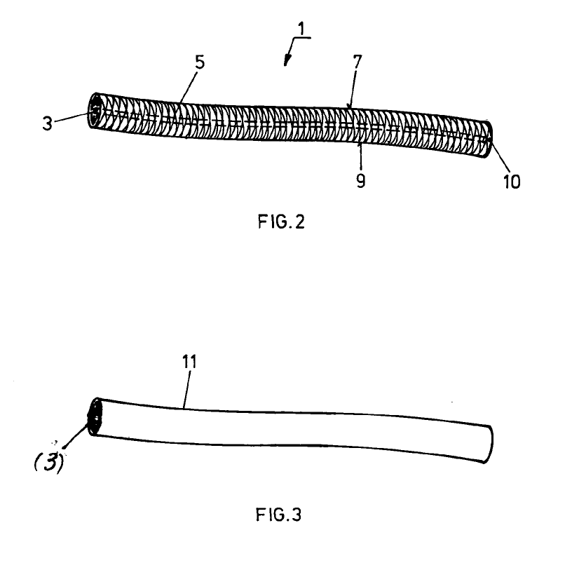

FIG. 2 shows the supporting body 1 after the braiding or laying procedure has ended, the laid fabric or braided fabric 5 being applied to the supporting core 1, which consists for example of a silicone-like material. During this application procedure, it was ensured that the density of the braided fabric or laid fabric is identical in the region of a slight curvature—with a relatively large radius denoted by 7 and with a relatively small radius denoted by 9. At one end of the supporting body 1, the woven fabric or laid fabric is “closed”, for example, by a knot 10 so as to simplify later removal of the supporting core.

It is of course also possible to firstly produce a stocking-like braided fabric or woven fabric in a separate step, which is then pulled or placed over the supporting core.

The elastomer supporting core 1 is then placed in an injection mold, for example, whereupon the binder is injected under pressure according to a known injection molding technique. It is of course also possible to apply the binder to the laid fabric or the braided fabric by lamination.

Metal filaments or wires, for example, introduced into the supporting core make it possible to heat the supporting core in order to additionally promote the curing of the binder. FIGS. 1 and 2 schematically show a central metal core 3, which can be used on the one hand for heating and on the other hand also to make it possible to remove the supporting core once the composite hollow article has cured. The heating of the elastomer core, such as for example the silicone supporting core, additionally simplifies removal, which is additionally promoted by the application of release agents to the elastomer supporting core.

Finally, FIG. 3 schematically shows the produced composite hollow article 11, which can be dimensioned in accordance with the intended use or can be provided with appropriate binders and laid fabrics.

Such composite hollow articles are used in the widest variety of applications, such as for example for sport equipment, such as bicycles, and in equipment for day-to-day use, etc. Such composite hollow articles, such as for example composite tubes, frequently replace metal tubes so as to reduce weight. In addition, by using suitable reinforcing materials such as, for example, carbon fibers, aramid fibers, etc., and by using highly-crosslinking binders, it is possible to obtain outstanding mechanical properties which can even surpass the properties of metal.

It goes without saying that the production method described with reference to FIGS. 1 to 3 is only an example for explaining the present invention in more detail. Thus, it is of course possible to use any suitable elastomer materials for the supporting body, although it is essential that they also remain dimensionally stable during the application of the reinforcing braided fabric or laid fabric. It is also the case that the braided fabric or laid fabric can be applied in the widest variety of ways; the circular braiding machine mentioned in the example is merely an example for making it possible to provide a better illustration of the present invention. Thus, a stocking-like or tube-like woven fabric already produced in advance can be drawn over the supporting core. The selection of the binder and also the material selection for the production of the braided fabric or laid fabric can also be made arbitrarily, i.e. depending on the demands made on the composite hollow article which is ultimately to be produced.

1. A method for the production of composite hollow articles, comprising the steps of applying a fabric selected from the group consisting of a braided fabric, a woven fabric and a laid fabric to an elongate supporting core which consists essentially of an elastomer material or an at least partially plastic or flexible material, strengthening the fabric by means of a curable binder, and removing the supporting core once the binder has cured.

2. The method as claimed in claim 1, wherein the fabric is a laid fabric which is applied to the core by means of a circular braiding machine, wherein, during production of the laid fabric on the core, the circular braiding machine is moved back and forth along the supporting core, depending on the thickness to be produced for the laid fabric.

3. The method as claimed in either of claim 1 or claim 2, wherein the supporting core is formed at least primarily a silicone material.

4. The method as claimed in claim 1 or claim 2, wherein at least one of a metal wire , a metal rod and a metal conductor passes through the supporting core, in the longitudinal direction.

5. The method as claimed in claim 1 or claim 2, wherein the supporting core is coated with a release agent on its outer surface.

6. The method as claimed in claim 1 or claim 2, wherein the supporting core is heated to heat the binder during curing.

7. The method as claimed in claim 1 or claim 2, wherein the binder is applied by lamination in order to strengthen the fabric.

8. The method as claimed in claim 1 or claim 2, wherein the binder used is selected from the group consisting of a reaction resin an epoxy resin, a polyester resin, and a polyurethane resin.

9. The method as claimed in claim 1 or claim 2, wherein at least one of substantially longitudinally running wires, fibers, filaments produced from fibers, and yarns produced from fibers are laid into the fabric , the fibers being selected from the group consisting of glass fibers, metal fibers, graphite fibers, and aramid fibers.

10. The method as claimed in claim 1 or claim 2, wherein before the fabric is applied, the supporting core is preformed into the shape to be produced for the composite hollow article, and then the fabric is applied.

11. The method as claimed in claim 1 or claim 2, wherein once the binder has cured, the supporting core is removed from the composite hollow article to be produced by being withdrawn laterally, and wherein the removal is promoted by heating the supporting core.

12. The method as claimed in claim 1 or claim 2, wherein the binder is applied by means of injection molding in order to strengthen the fabric.

13. The method as claimed in claim 1 or claim 2, wherein the composite hollow articles are tubular composite hollow articles.
